(19) United States
(12) Patent Application Publication
(10) Pub. No.: US 2022/0209351 A1
(43) Pub. Date: Jun. 30, 2022

(54) BATTERY SYSTEM OF VEHICLE

(71) Applicant: HYUNDAI MOBIS Co., Ltd., Seoul (KR)

(72) Inventors: Jae Seung LEE, Seongnam-si (KR); Sang Chul JO, Geoje-si (KR)

(73) Assignee: HYUNDAI MOBIS Co., Ltd., Seoul (KR)

(21) Appl. No.: 17/561,039

(22) Filed: Dec. 23, 2021

(30) Foreign Application Priority Data
Dec. 24, 2020 (KR) 10-2020-0183876

(51) Int. Cl. H01M 50/242; H01M 50/505; H01M 50/209; B60R 16/033; B60R 16/02

(52) U.S. Cl. CPC H01M 50/242; H01M 50/505; H01M 2220/20; B60R 16/033; B60R 16/0215; H01M 50/209

(57) ABSTRACT

A battery system of a vehicle includes: a plurality of battery modules each including a battery cell assembly and a bus bar; an upper case spaced apart from an upper portion of the battery modules; a wire harness disposed between the battery modules and the upper case to be connected to the battery modules; elastic pads spaced apart along a longitudinal direction of the wire harness to fix the wire harness; and a plurality of elastic bodies respectively disposed at an upper end and a lower end of the bus bars to fix the bus bars.

### CROSS-REFERENCE TO RELATED APPLICATION

This application claims priority to and the benefit of Korean Patent Application No. 10-2020-0183876, filed on Dec. 24, 2020, the disclosure of which is incorporated herein by reference in its entirety.

### BACKGROUND

### 1. Field of the Invention

The present invention relates to a battery system of a vehicle.

### 2. Discussion of Related Art

Generally, a battery system of a vehicle adopts a taping method to fix a high voltage line.

However, the taping method has a problem in that a process is complicated and a long time is taken, and there is also a safety problem in that an energized part (current carrying part) of the high voltage line is exposed due to vibrations caused by an external shock.

### SUMMARY OF THE INVENTION

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a battery system of a vehicle includes: a plurality of battery modules, each battery module including a battery cell assembly and a bus bar; an upper case spaced apart from an upper portion of the battery modules; a wire harness disposed between the battery modules and the upper case to be connected to the battery modules; elastic pads spaced apart along a longitudinal direction of the wire harness to fix the wire harness; and a plurality of elastic bodies respectively disposed at an upper end and a lower end of the bus bars to fix the bus bars.

A plurality of fixing grooves may be disposed in an upper end of the elastic pads, and the wire harness may be configured to be forcedly fitted into the fixing grooves.

The upper case may cover the battery modules in a state of meeting the elastic pads and the elastic bodies for each of a plurality of sections.

The plurality of elastic bodies may be disposed at regular intervals along a longitudinal direction of the bus bars.

In another general aspect, a battery system of a vehicle includes: a plurality of battery modules, each battery module including a battery cell assembly; a plurality of bus bars connected to the battery modules; a plurality of elastic bodies disposed at an upper end and a lower end of the bus bars to fix the bus bars; and an upper case configured to cover an upper end of the battery modules with the elastic bodies at the upper ends of the bus bars therebetween.

The plurality of elastic bodies may be separately attached to the upper ends and the lower ends of the bus bars.

First and second elastic bodies of the plurality of elastic bodies configured to surround the upper ends and the lower ends of the bus bars may be configured as one detachable combined body.

Each elastic body may have a thickness a same as an interval between the bus bars and the upper case or exceeding the interval between the bus bars and the upper case by an elastic range.

In another general aspect, a battery system of a vehicle includes: a plurality of battery modules, each battery module including a battery cell assembly; an upper cover configured to cover an upper end of the battery modules; an upper case configured to cover an upper end of the upper cover; a wire harness disposed between the upper cover and the upper case, and connected to the battery modules; and elastic pads disposed along a longitudinal direction of the wire harness and spaced apart from the upper cover to fix the wire harness.

The elastic pads may include a plurality of fixing grooves into which the wire harness is forcedly fitted.

The fixing grooves may be formed in a narrow and elongated shape formed along a longitudinal direction of the elastic pads, and may include a plurality of protrusions which protrude inward and are alternately disposed.

Each elastic pad may be detachably attached to the upper cover.

Each elastic pad may be snap-fit fastened to the upper cover.

Each elastic pad may be slidably fastened to the upper cover.

Other features and aspects will be apparent from the following detailed description, the drawings, and the claims.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic perspective view of a battery system of a vehicle according to one embodiment of the present invention other than an upper case for convenience of component identification;

FIG. 2 is a partial cross-sectional view schematically illustrating the battery system of a vehicle according to one embodiment of the present invention;

FIG. 3 is a view partially illustrating an elastic pad which fixes a wire harness in the battery system of a vehicle according to one embodiment of the present invention;

FIG. 4 is a view partially illustrating elastic bodies which fix a bus bar in the battery system of a vehicle according to one embodiment of the present invention; and

FIGS. 5 and 6 are views illustrating an example of application of the elastic bodies in the battery system of a vehicle according to one embodiment of the present invention.

### DETAILED DESCRIPTION OF EXEMPLARY EMBODIMENTS

Advantages and features of the present invention, and a method of achieving them, will be apparent with reference to embodiments which is described in detail in conjunction with the accompanying drawings. However, the present invention is not limited to the embodiments which will be described below and may be implemented in different forms. The embodiments are only provided to completely disclose the present invention and completely convey the scope of the present invention to those skilled in the art, and the present invention is defined by the disclosed claims. Meanwhile, terms used in the description are provided not to limit the present invention but to describe the embodiments. In the embodiments, the singular form is intended to also include the plural form unless the context clearly indicates otherwise. The terms ‘comprise’ and/or ‘comprising’ as used herein do not preclude the presence or addition of at least one other component, step, operation, and/or element other than the stated components, steps, operations and/or elements.

Hereinafter, preferable embodiments of the present invention will be described in detail with reference to the accompanying drawings.

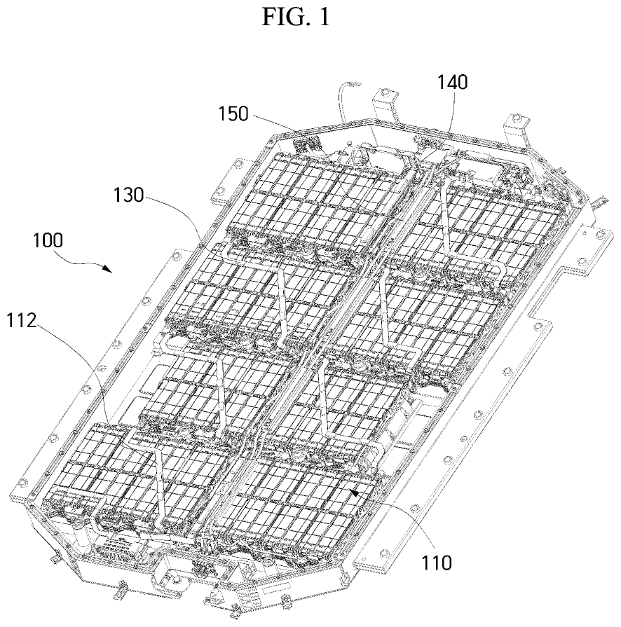

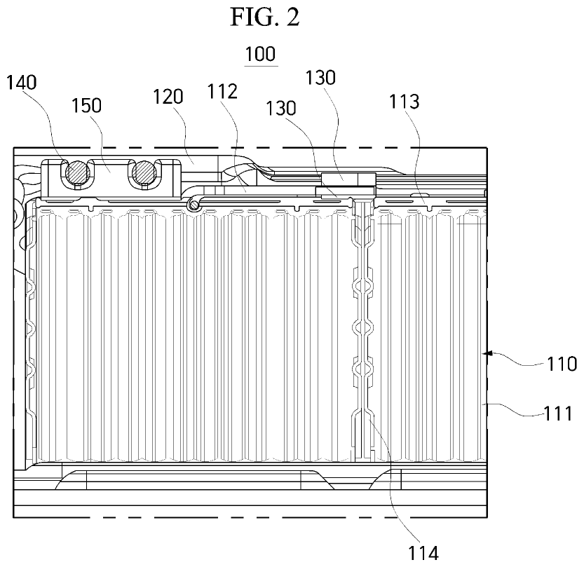

FIG. 1 is a schematic perspective view of a battery system of a vehicle other than an upper case for convenience of component identification, and FIG. 2 is a partial cross-sectional view schematically illustrating the battery system of a vehicle.

Referring to FIGS. 1 and 2, a battery system of a vehicle 100 according to one embodiment of the present invention includes battery modules 110, an upper case 120, elastic bodies 130, a wire harness 140 and elastic pads 150.

The battery module 110 includes an assembly of a plurality of battery cells 111 and a bus bar 112. The bus bar 112 is electrically connected to the battery cell 111.

The upper case 120 is disposed to be spaced apart from an upper portion of the battery module 110.

A plurality of elastic bodies 130 are respectively disposed at upper and lower ends of the bus bar 112 to securely fix the bus bar 112. The plurality of elastic bodies 130 are disposed at regular intervals along a longitudinal direction of the bus bar 112.

The wire harness 140 is disposed between the battery modules 110 and the upper case 120. This wire harness 140 is connected to the battery modules 110.

The elastic pads 150 are disposed along a longitudinal direction of the wire harness 140 to be spaced apart to fix the wire harness 140.

The elastic body 130 and the elastic pad 150 meet the upper case 120 for each section, and the upper case 120 has a structure of covering the battery modules 110 in this state.

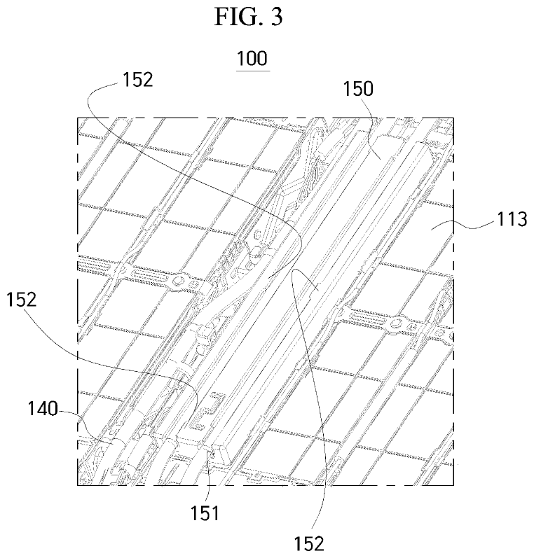

FIG. 3 is a view partially illustrating the elastic pad which fixes the wire harness in the battery system of a vehicle according to one embodiment of the present invention.

Referring to FIG. 3, a plurality of fixing grooves 151 into which the wire harness 140 is forcedly fitted are formed in an upper end of the elastic pad 150.

Each of the fixing grooves 151 is formed in a narrow and elongated shape formed along a longitudinal direction of the elastic pad 150. This fixing groove 151 includes protrusions 152 which protrude inward and are alternately disposed.

A diameter of the wire harness 140 corresponds to an inner diameter of the fixing groove 151, and the protrusions 152 are located at upper ends of the fixing groove 151 so that the wire harness 140 is securely fixed to the fixing groove 151.

That is, when the wire harnesses 140 are forcedly fitted into the plurality of fixing grooves 151 formed in the plurality of elastic pads 150 disposed in a line, the protrusions 152 serve to prevent easy separation of the wire harnesses 140 from the fixing grooves 151.

Meanwhile, the elastic pad 150 may be detachably attached to an upper cover 113, and as another example, may be detached from the upper cover 113 in a sliding manner.

As another example, the elastic pad 150 may have a structure capable of snap-fit fastening to the upper cover 113.

The elastic pad 150 of the present invention may more effectively regulate a position of the wire harness 140 compared to a conventional taping or overlapping method, and may improve workability in an assembly line.

Specifically, the elastic pad 150 may surround and protect an entire region of the wire harness 140, and thus may ensure safety compared to the conventional method. In other words, the elastic pad 150 has a characteristic of protecting not only the upper and lower ends of the wire harness 140 but also the entire region thereof.

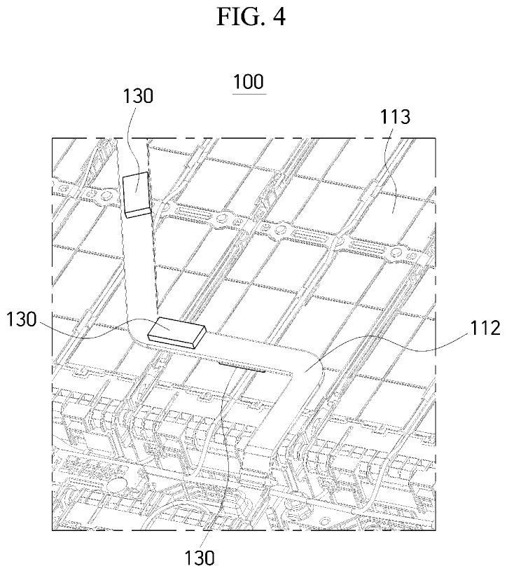

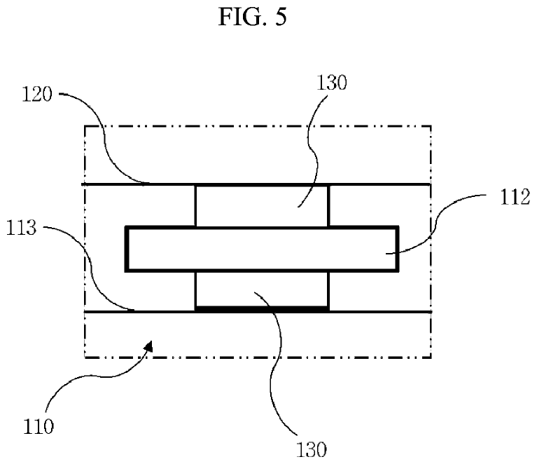

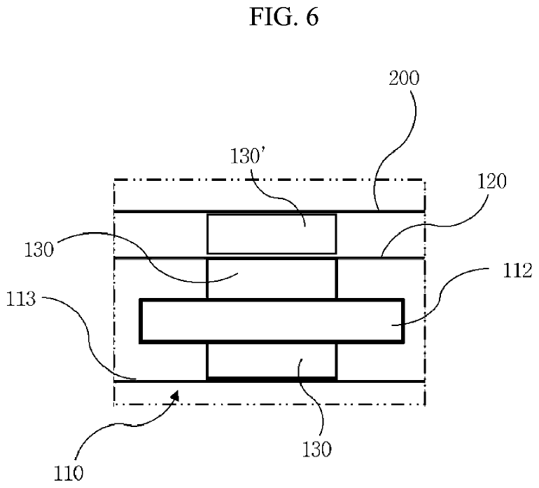

FIG. 4 is a view partially illustrating the elastic bodies which fix the bus bar in the battery system of a vehicle according to one embodiment of the present invention, and FIGS. 5 and 6 are views illustrating an example of application of the elastic bodies.

Accordingly, referring to FIGS. 4 to 6, the elastic bodies 130 are basically located at the upper and lower ends of the bus bar 112.

These elastic bodies 130 are disposed in one line with respect to the bus bar 112 to fix a Z-axis of the bus bar 112. When a shock is generated by vehicle vibrations or external vibrations, the elastic bodies 130 prevent interference between the bus bar 112 and the battery modules 110.

In this case, the elastic body 130 may have a thickness the same as or exceeding an interval between the bus bar 112 and the upper case 120 by an elastic range.

Meanwhile, as shown in FIG. 6, an elastic body 130′ may be disposed between the upper case 120 and an empty space of a vehicle body 200. Here, the elastic body 130′ serves to alleviate a shock of the vehicle battery system itself caused by the external vibrations.

Although not shown, the plurality of elastic bodies 130 may be attached to the upper and lower ends of the bus bar 112 in a separable structure. That is, first and second elastic bodies (not shown) surrounding the upper and lower ends of the bus bar 112 may be configured as one detachable combined body.

According to the present invention, a battery system of a vehicle can simplify an assembly process by adopting a method of simply attaching elastic bodies and an elastic pad which respectively fix a bus bar and a wire harness, and can secure safety by preventing exposure of an energized part of a high voltage line.

Specifically, the battery system of a vehicle can prevent interference between an upper cover and a battery module and the bus bar by minimizing vibrations caused by an external shock.

The present invention is not limited to the above-described embodiments, and may be implemented with various modifications within the scope of the technical spirit of the present invention.

What is claimed is:

1. A battery system of a vehicle, comprising:
a plurality of battery modules, each battery module including a battery cell assembly and a bus bar;
an upper case spaced apart from an upper portion of the battery modules;
a wire harness disposed between the battery modules and the upper case and connected to the battery modules;
elastic pads spaced apart along a longitudinal direction of the wire harness to fix the wire harness; and
a plurality of elastic bodies disposed at an upper end and a lower end of the bus bars to fix the bus bars.

2. The battery system of claim 1, wherein a plurality of fixing grooves are disposed in an upper end of the elastic pads, and the wire harness is configured to be forcedly fitted into the fixing grooves.

3. The battery system of claim 1, wherein the upper case covers the battery modules in a state of meeting the elastic pads and the elastic bodies for each of a plurality of sections.

4. The battery system of claim 1, wherein the plurality of elastic bodies is disposed at regular intervals along a longitudinal direction of the bus bars.

5. A battery system of a vehicle, comprising:
a plurality of battery modules, each battery module including a battery cell assembly;
a plurality of bus bars connected to the battery modules;
a plurality of elastic bodies disposed at an upper end and a lower end of the bus bars to fix the bus bars; and
an upper case configured to cover an upper end of the battery modules with the elastic bodies at the upper ends of the bus bars therebetween.

6. The battery system of claim 5, wherein the plurality of elastic bodies are separately attached to the upper ends and the lower ends of the bus bars.

7. The battery system of claim 5, wherein first and second elastic bodies of the plurality of elastic bodies configured to surround the upper ends and the lower ends of the bus bars are configured as one detachable combined body.

8. The battery system of claim 5, wherein each elastic body has a thickness a same as an interval between the bus bars and the upper case or exceeding the interval between the bus bars and the upper case by an elastic range.

9. A battery system of a vehicle, comprising:
a plurality of battery modules, each battery module including a battery cell assembly;
an upper cover configured to cover an upper end of the battery modules;
an upper case configured to cover an upper end of the upper cover;
a wire harness disposed between the upper cover and the upper case, and connected to the battery modules; and
elastic pads disposed along a longitudinal direction of the wire harness and spaced apart from the upper cover to fix the wire harness.

10. The battery system of claim 9, wherein the elastic pads include a plurality of fixing grooves into which the wire harness is forcedly fitted.

11. The battery system of claim 10, wherein the fixing grooves are formed in a narrow and elongated shape formed along a longitudinal direction of the elastic pads, and include a plurality of protrusions which protrude inward and are alternately disposed.

12. The battery system of claim 9, wherein each elastic pad is detachably attached to the upper cover.

13. The battery system of claim 9, wherein each elastic pad is snap-fit fastened to the upper cover.

14. The battery system of claim 9, wherein each elastic pad is slidably fastened to the upper cover.
